(19) United States
(12) Patent Application Publication
(10) Pub. No.: US 2009/0027437 A1
(43) Pub. Date: Jan. 29, 2009

(54) LIQUID EJECTING APPARATUS AND LIQUID EJECTING METHOD

(75) Inventors: Nobuaki AZAMI, Matsumoto-shi (JP); Hirokazu NUNOKAWA, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/178,265

(22) Filed: Jul. 23, 2008

(30) Foreign Application Priority Data
Jul. 24, 2007 (JP) 2007-192226

(51) Int. Cl. B41J 29/38

(52) U.S. Cl. 347/17

(57) ABSTRACT

A liquid ejecting apparatus includes a plurality of heads that eject liquids, a plurality of driving signal generating units that are disposed in the plurality of heads and generate driving signals used for driving the plurality of heads, a temperature control unit that controls temperatures of the liquids, a supply path that supplies the liquids of which temperatures are controlled by the temperature control unit to the plurality of heads, and a controller that changes the driving signals, which are generated by the plurality of driving signal generating units corresponding to the plurality of heads, based on the temperatures of the liquids in the plurality of heads.

### BACKGROUND

1. Technical Field

The present invention relates to a liquid ejecting apparatus and a liquid ejecting method.

2. Related Art

As a print apparatus that prints an image on a medium such as a paper sheet, a cloth, or an OHP sheet, ink jet printers are widely known. In the ink jet printers, as ink is ejected from a head and lands on the medium, a dot is formed. In addition, an image is printed by forming innumerable dots on the medium. Among the ink jet printers, there is a type, in which ink is ejected from fixed heads without moving the heads by using a carriage, called a line printer.

In the line printers, the nozzles are needed to be aligned in the length of the medium width. However, it is difficult to provide a nozzle that covers the length of the medium width. In addition, in order to provide the nozzle that covers the length of the medium width, a high cost is required. Accordingly, technology in which nozzles that cover the length of the medium width are disposed by preparing a plurality of heads and aligning the plurality of nozzles has been proposed.

JP-A-2006-256262 is an example of related art. As the temperature of ink is lowered, the viscosity of the ink increases. As a result, there is a possibility that a pressure loss in a supply path that supplies ink increases to disturb the flow of the ink or the amount of ink ejected from a head becomes unstable. Thus, it may be considered that the temperature of ink is adjusted and the ink of which temperature is adjusted is supplied to the head.

However, when there is a plurality of heads, the temperatures of ink in the heads may be different from one another. In such a state, when the heads are driven by using a same driving signal, the amounts of ink ejected from the heads are different from one another, and thereby there is a possibility that the quality of an image is deteriorated.

In addition, the problem that the amounts of liquids ejected from the heads are different is not limited to the line printer, and the problem may occur in a liquid ejecting apparatus having a plurality of heads.

### SUMMARY

An advantage of some aspects of the invention is that irregularity of the amounts of ejection among heads is suppressed.

According to a major aspect of the present invention, there is provided a liquid ejecting apparatus including: a plurality of heads that eject liquids; a plurality of driving signal generating units that are disposed in the plurality of heads and generate driving signals used for driving the plurality of heads; a temperature control unit that controls temperatures of the liquids; a supply path that supplies the liquids of which temperatures are controlled by the temperature control unit to the plurality of heads; and a controller that changes the driving signals, which are generated by the plurality of driving signal generating units corresponding to the plurality of heads, based on the temperatures of the liquids in the plurality of heads.

Other aspects of the invention will become apparent by descriptions of this specification and the accompanying drawings.

### BRIEF DESCRIPTION OF THE DRAWINGS

The invention will be described with reference to the accompanying drawings, wherein like numbers reference like elements.

FIG. 1 is a diagram showing the external configuration of a printing system according to an embodiment of the present invention.

FIG. 2 is a block diagram showing the whole configuration of a printer 1 according to an embodiment of the invention.

FIG. 3A is a cross-section view of the printer 1.

FIG. 3B is a perspective view showing transport and dot forming processes of the printer 1.

FIG. 4A is a diagram showing arrangement of a plurality of heads on a lower surface of a head unit 40 according to an embodiment of the invention.

FIG. 4B is a diagram showing position relationship of heads according to an embodiment of the invention.

FIG. 5 is a diagram showing various signals according to an embodiment of the invention.

FIG. 6 is a diagram showing supply of ink to a head according to an embodiment of the invention head.

FIG. 7 is a schematic diagram showing the configuration of a first embodiment of the invention.

FIG. 8 is a flowchart of the first embodiment.

FIG. 9 is a diagram for describing an electric potential difference determining table according to an embodiment of the invention.

FIG. 10 is a diagram showing a driving pulse PS12 and an electric potential difference Vh according to an embodiment of the invention.

FIG. 11 is a diagram showing flow amount history data according to an embodiment of the invention.

FIG. 12 is a flowchart showing the temperature calculating process according to the second embodiment.

FIGS. 13A to 13C are diagrams showing a process for calculating an arrival time period according to an embodiment of the invention.

FIG. 14 is a diagram showing a modified example of a supply path.

FIG. 15 is a flowchart showing a modified example of a temperature calculating process.

FIG. 16A is a diagram showing a process for calculating second arrival time periods from a branch point 94 to heads 41.

FIG. 16B is a diagram showing a process for calculating a first arrival time period from a heater 81 to the branch point 94.

### DESCRIPTION OF EXEMPLARY EMBODIMENTS

At least the following aspects become apparent with reference to descriptions below and the accompanying drawings.

According to a first aspect of the invention, there is provided a liquid ejecting apparatus including: a plurality of heads that eject liquids; a plurality of driving signal generating units that are disposed in the plurality of heads and generate driving signals used for driving the plurality of heads; a temperature control unit that controls temperatures of the liquids; a supply path that supplies the liquids of which temperatures are controlled by the temperature control unit to the plurality of heads; and a controller that changes the driving signals, which are generated by the plurality of driving signal generating units corresponding to the plurality of heads, based on the temperatures of the liquids in the plurality of heads.

According to the above-described liquid ejecting apparatus, irregularity of ejection amounts among the heads can be suppressed.

In the liquid ejecting apparatus, it is preferable that a plurality of temperature sensors that are disposed in the plurality of heads and are used for detecting the temperatures of the liquids in the plurality of heads is further included and the controller changes the driving signals, which are generated by the driving signal generating units corresponding to the plurality of heads, based on results of detection of the plurality of temperature sensors. In such a case, irregularity of ejection amounts among the heads can be suppressed.

In the liquid ejecting apparatus, it is preferable that a temperature sensor that is disposed in the supply path and is used for detecting the temperature of the liquids in the supply path is further included and the controller changes the driving signals, which are generated by the driving signal generating units corresponding to the plurality of heads, based on a result of detection of the temperature sensor. In such a case, irregularity of ejection amounts among the heads can be suppressed.

In the liquid ejecting apparatus, it is preferable that the controller calculates the temperatures of the liquids in the plurality of heads based on flow amounts of the liquids supplied to the plurality of heads. In such a case, the temperatures of the liquids in the heads can be acquired without directly detecting the temperatures of the liquids.

In the liquid ejecting apparatus, it is preferable that the controller controls ejection of the liquids from the plurality of heads based on print data and the controller calculates the flow amounts of the liquids supplied to the plurality of heads based on the print data and calculates the temperatures of the liquids in the plurality of heads based on the calculated flow amounts. In such a case, the temperatures of the liquids in the heads can be acquired without using a temperature sensor.

In the liquid ejecting apparatus, it is preferable that the controller calculates arrival time periods in which the liquids reach the plurality of heads from the temperature control unit based on the flow amounts of the liquids supplied to the plurality of heads and calculates the temperatures of the liquids in the plurality of heads based on the arrival time periods. In such a case, the temperatures of the liquids in the heads can be calculated with a temperature change due to heat emission of the liquids in the supply path considered.

In the liquid ejecting apparatus, it is preferable that the supply path includes a common supply path, a branch point, and a plurality of branched supply paths, the liquids of which temperatures have been controlled by the temperature control unit flow through the common supply path, then are branched at the branch point, and flow through the branched supply paths to be supplied to the plurality of heads, and the controller calculates arrival time periods in which the liquids reach the plurality of heads from the branched point and then calculates arrival time periods in which the liquids reach the branch point from the temperature control unit. In such a case, the temperatures of the liquids in the heads can be precisely acquired.

In the liquid ejecting apparatus, it is preferable that the controller, for calculating the temperature of the liquid in a head among the plurality of heads, calculates an arrival time period, in which the liquid reaches the head from the branch point, based on the flow amount of the liquid supplied to the head and calculates an arrival time period, in which the liquid reaches the branch point from the temperature control unit, based on the flow amount of the liquid supplied to the head and the flow amount of the liquid supplied to another head. In such a case, the temperature of the liquid in each head can be precisely acquired.

According to a second aspect of the invention, there is provided a liquid ejecting method for ejecting liquids from a plurality of heads. The method includes: controlling temperatures of the liquids; supplying the liquids of which temperatures are controlled to the plurality of heads; changing driving signals used for driving the plurality of heads based on the temperatures of the liquids in the plurality of heads, and ejecting the liquids from the plurality of heads by driving the plurality of heads by using the changed driving signals.

According to the above-described liquid ejecting method, irregularity of ejection amounts among the heads can be suppressed.

### Configuration of Printing System

Next, embodiments of a printing system will be described with reference to the accompanying drawings. However, in descriptions below, embodiments of a computer program, a recording medium having the computer program recorded thereon, and the like are included.

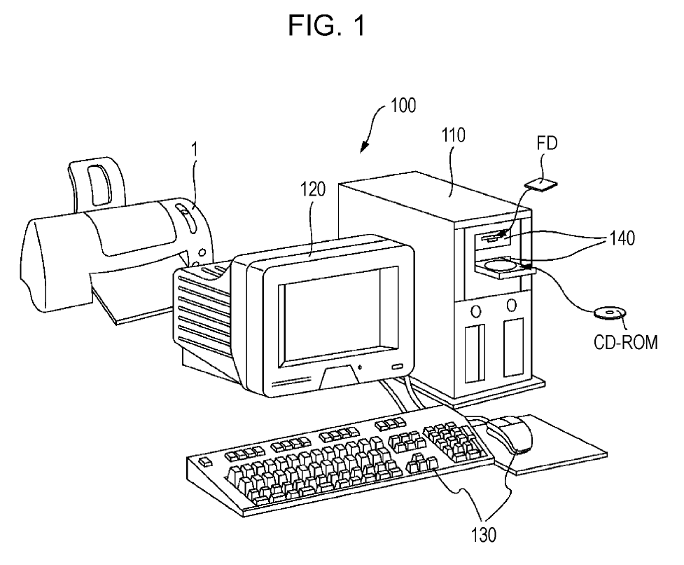

FIG. 1 is a diagram showing the external configuration of a printing system. The printing system 100 includes a printer 1, a computer 110, a display device 120, an input device 130, and a record reproducing device 140. Here, the printer 1 is a print apparatus that prints an image on a medium such as a paper sheet, a cloth, or a film. The computer 110 is interconnected with the printer 1 for communication, and outputs print data on the basis of an image to be printed to the printer 1 for enabling the printer 1 to print an image.

In the computer 110, a printer driver is installed. The printer driver is a program used for converting the image data output from an application program into print data by displaying a user interface in the display device 120. The printer driver is recorded in a recording medium (computer-readable recording medium) such as a flexible disk FD or a CD-ROM. Alternatively, the printer driver may be downloaded to the computer 110 through the Internet. The program is constituted by codes used for implementing various functions.

Here, the print apparatus represents an apparatus that prints an image on a medium, and, for example, the printer 1 corresponds to the print apparatus. In addition, a print control device represents a device that controls the print apparatus, and, for example, a computer in which the printer driver is installed corresponds to the print control device. A printing system represents a system including at least the print apparatus and the print control device.

### Configuration of Printer

### Configuration of Ink Jet Printer

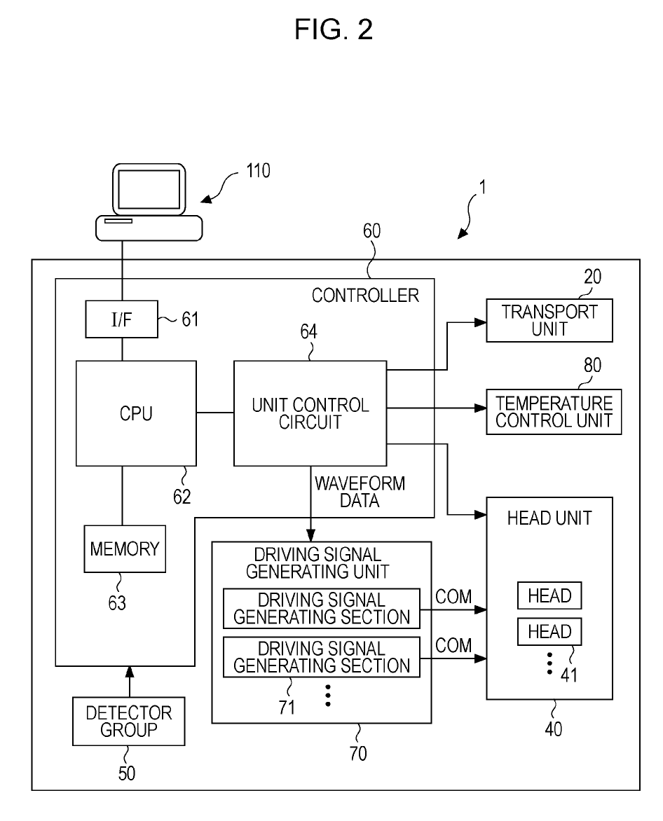

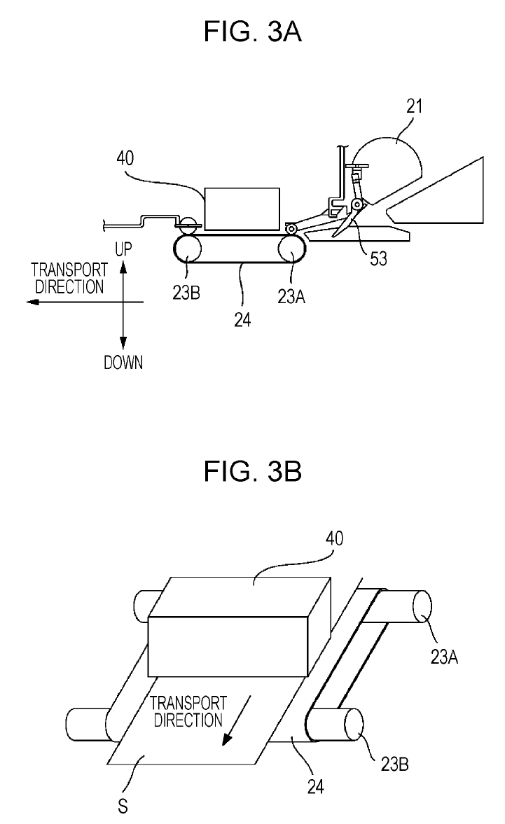

FIG. 2 is a block diagram showing the whole configuration of the printer 1. FIG. 3A is a cross-section view of the printer 1. In addition, FIG. 3B is a perspective view showing transport and dot forming processes of the printer 1. Here, the basic configuration of a line printer that is a printer according to this embodiment will be described.

The printer 1 according to this embodiment includes a transport unit 20, a head unit 40, a detector group 50, a controller 60, a driving signal generating unit 70, and a temperature control unit 80. The printer 1 that has received print data from the computer 110 as an external device controls its constituent units (the transport unit 20, the head unit 40, and the driving signal generating unit, and the temperature control unit) by using the controller 60. The controller 60 prints an image on a paper sheet by controlling the constituent units based on the print data received from the computer 110. The status inside the printer 1 is monitored by the detector group 50, and the detector group 50 outputs the result of detection to the controller 60. The controller 60 controls the constituent units based on the result of detection output from the detector group 50.

The transport unit 20 is used for transporting a medium (for example, a paper sheet S or the like) in a predetermined direction (hereinafter, referred to as a transport direction). The transport unit 20 includes a paper feed roller 21, a transport motor (not shown), an upstream transport roller 23A, a downstream transport roller 23B, and a belt 24. The paper feed roller 21 is a roller used for feeding a paper sheet, which is inserted into a paper insertion opening, inside the printer. When the transport motor not shown in the figure is rotated, the upstream transport roller 23A and the downstream transport roller 23B are rotated so as to rotate the belt 24. The paper sheet S fed by the paper feed roller 21 is transported to a printable area (an area facing the head) by the belt 24. As the belt 24 transports the paper sheet S, the paper sheet S is moved in the transport direction with respect to the head unit 40. The paper sheet S that has passed the printable area is discharged externally by the belt 24. The paper sheet S in a transport process is electrostatically adsorbed or vacuum-adsorbed to the belt 24.

The head unit 40 is used for ejecting ink on a paper sheet S. The head unit 40 forms dots on the paper sheet S by ejecting ink onto the paper sheet S in the transport process, and thereby printing an image on the paper sheet S. The printer according to this embodiment is a line printer and the head unit 40 can simultaneously form dots in the paper width. The configuration of the head unit 40 will be described later.

The detector group 50 includes a rotary encoder (not shown), a paper detecting sensor 53, and the like. The rotary encoder detects the amounts of rotation of the upstream transport roller 23A and rotation of the downstream transport roller 23B. The amount of transport of the paper sheet S can be detected based on the result of detection of the rotary encoder. The paper detecting sensor 53 detects the position of a front end of a paper sheet to be fed. In addition, a temperature sensor 51 to be described later is included in the detector group 50.

The controller 60 is a control unit (control part) for controlling the printer. The controller 60 includes an interface unit 61, a CPU 62, a memory 63, and a unit control circuit 64. The interface unit 61 performs transmission and reception of data between the computer 110 as an external apparatus and the printer 1. The CPU 62 is an arithmetic processing device for controlling the overall operation of the printer. The memory 63 is used for acquiring an area in which a program of the CPU 62 is stored or a work area and has a memory element such as a RAM or an EEPROM. The CPU 62 controls the constituent units in accordance with the program stored in the memory 63 through the unit control circuit 64.

The driving signal generating unit 70 is used for generating a driving signal COM used for driving the head unit 40. The driving signal generating unit 70 includes a plurality of driving signal generating sections 71. When the controller 60 sets waveform data to each driving signal generating section 71, the driving signal generating section 71 generates a driving signal COM having a waveform corresponding to the waveform data.

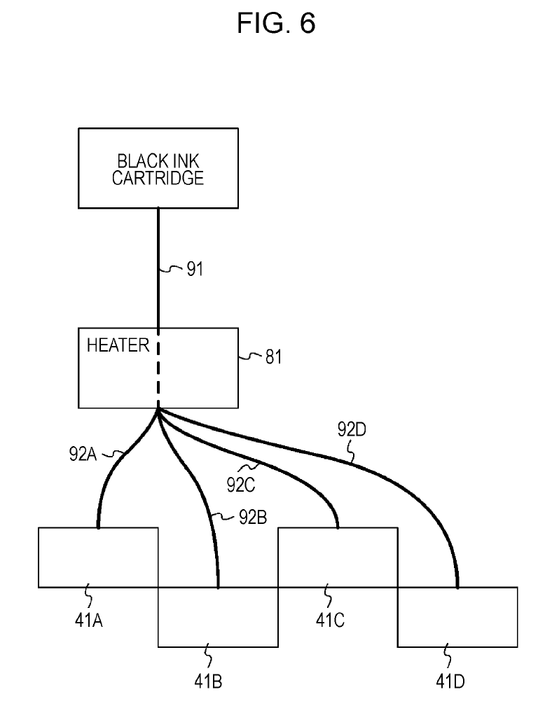

The temperature control unit 80 is used for controlling the temperature of ink supplied to the head unit 40. In the temperature control unit 80, a heater (see FIG. 6) is disposed, and the temperature control unit 80 can control the temperature of the ink by using heat emission from the heater. The controller 60 can control the heater of the temperature control unit 80. The temperature control unit 80 and supply of the ink will be described later.

### Configuration of Head Unit 40

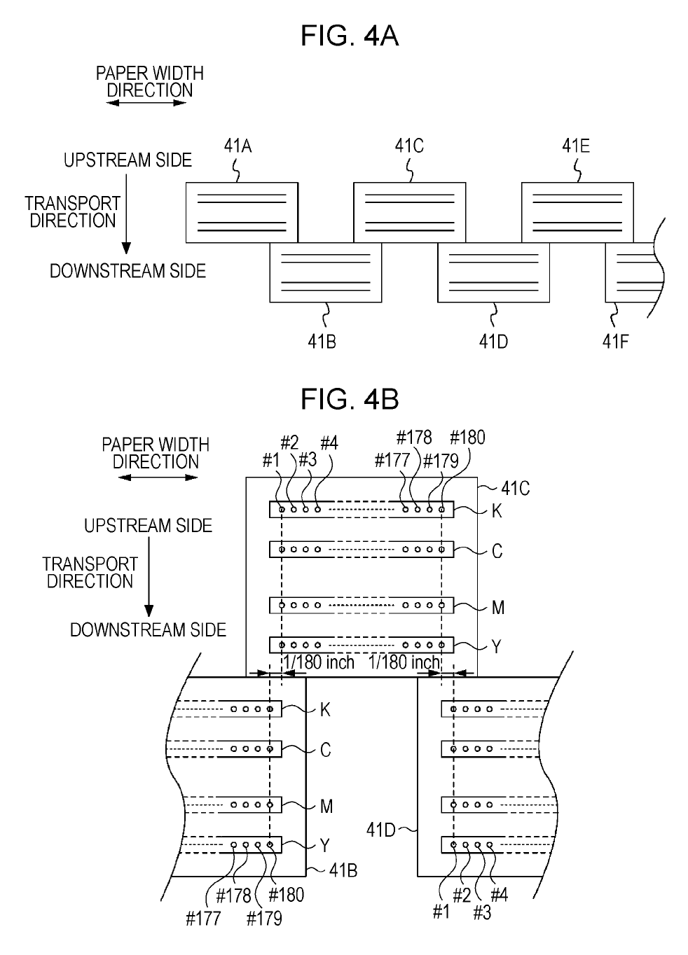

FIG. 4A is a diagram showing arrangement of a plurality of heads on the lower surface of the head unit 40. FIG. 4B is a diagram showing position relationship of the heads. The lower surface of the head unit is configured to face the paper sheet S that is transported by the belt 24.

On the lower surface of the head unit 40, a plurality of heads is aligned in a zigzag pattern. In a description below, in order from the left side of the figure, heads will be referred to as a first head 41A, a second head 41B, a third head 41C, a fourth head 41D, and so on. On the upstream side in the transport direction, odd-numbered heads of the first head 41A, the third head 41C, the fifth head 41E, and so on are aligned in the paper width direction. In addition, on the downstream side in the transport direction, even-numbered heads of the second head 41B, the fourth head 41D, the sixth head 41F, and so on are aligned in the paper width direction.

In each head, a black ink nozzle array K, a cyan ink nozzle array C, a magenta ink nozzle array M, and a yellow ink nozzle array Y are formed. Each nozzle array includes a plurality of (180 in this embodiment) nozzles that are ejection openings for ejecting ink. The plurality of nozzles of each nozzle array is aligned with a constant nozzle pitch along the paper width direction. Here, the nozzle pitch is 1/180 inch. To the nozzles of each nozzle array, nozzle numbers are sequentially attached from the left side in the figure (#1 to #180).

A gap in the paper width direction between nozzle #1 in the left end of an odd-numbered head (for example, the third head 41C) located on the upstream side in the transport direction and nozzle #180 in the right end of an even-numbered head (for example, the second head 41B) located on the downstream side in the transport direction is 1/180 inch that is the same as that of the nozzle pitch. In addition, a gap in the paper width direction between nozzle #180 in the right end of an odd-numbered head (for example, the third head 41C) located on the upstream side of the transport direction and nozzle #1 in the left end of an even-numbered head (for example, the fourth head 41D) located on the downstream side of the transport direction is 1/180 inch that is the same as the nozzle pitch.

By disposing the head as described above, the nozzles can be disposed with gaps of 1/180 inch in the paper width direction over the paper width of a print sheet to be printed. In addition, by disposing the head as described above, the head unit 40 can form dots (a dot array), which are aligned with gaps of 1/180 inch in the paper width direction, over a length of the paper width.

### Driving Signal COM

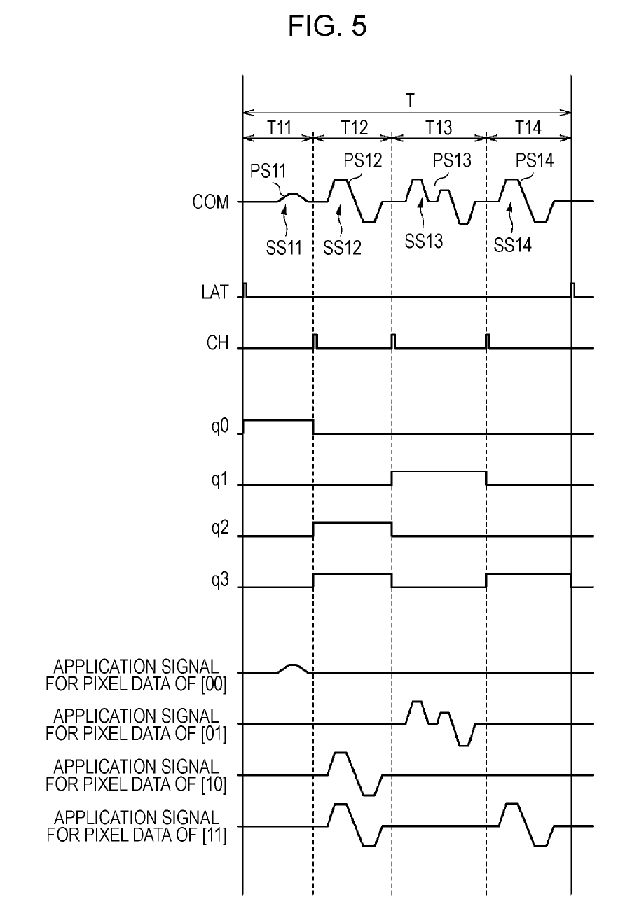

FIG. 5 is a diagram showing various signals. On the upside of the figure, a waveform of a driving signal COM for one period is shown. The driving signal generating section 71 repeatedly outputs the driving signal COM shown in the figure. While the driving signal COM for one period is output, the paper sheet S is transported by 1/180 inch by the transport unit 20. In other words, every time the paper sheet is transported by 1/180 inch, the driving signal generating section 71 repeatedly outputs the driving signal COM for one period which is shown in the figure.

Each repeated period T can be divided into four intervals T11 to T14. In a first interval T11, a first interval signal SS11 including a driving pulse PS11 is generated. In a second interval T12, a second interval signal SS12 including a driving pulse PS12 is generated. In addition, a third interval signal SS13 including a driving pulse PS13 is generated in a third interval T13, and a fourth interval signal SS14 including a driving pulse PS14 is generated in a fourth interval T14.

The pulse of latch signal LAT is generated every time a paper sheet is transported by 1/180 inch. By repeatedly generating this pulse and acquiring the period of the pulse, a transport speed is acquired.

In addition, change signal CH is a signal for representing the four intervals T11 to T14. Every time a predetermined time elapses after latch signal LAT is generated, the pulse of change signal CH is generated.

In addition, selection signals q0 to q3 are signals used for turning switches on or off. The selection signals q0 to q3 become level L or level H for each interval. In each nozzle, a piezo element and a switch are disposed. When the selection signal is level H, the switch is turned on, and accordingly, the driving signal COM is applied to the piezo element.

In the print data that is received from the computer 110, image data representing an image to be printed is included. In the image data, a plurality of pixel data is included. Each pixel data is configured by two bits. Dots to be formed in pixels are represented by the data of two bits. The controller 60 ejects ink from nozzles based on the pixel data included in the print data, and thereby forming dots on a paper sheet.

When the pixel data is [00], the switch is turned on and off in accordance with the selection signal q0, the first interval signal SS11 of the driving signal COM is applied to the piezo element, and the piezo element is driven in accordance with the driving pulse PS11. When the piezo element is driven in accordance with the driving pulse PS11, a change in the pressure of the ink which does not incur ejection of ink occurs, and an ink meniscus (a free surface of ink exposed to a nozzle part) is vibrated minutely.

When the pixel data is [01], the switch is turned on and off in accordance with the selection signal q1, the third interval signal SS13 of the driving signal COM is applied to the piezo element, and the piezo element is driven in accordance with the driving pulse PS13. When the piezo element is driven in accordance with the driving pulse PS13, a small amount of ink is ejected, and thereby a small dot is formed on the paper sheet.

When the pixel data is [10], the switch is turned on and off in accordance with the selection signal q2, the second interval signal SS12 of the driving signal COM is applied to the piezo element, and the piezo element is driven in accordance with the driving pulse PS12. When the piezo element is driven in accordance with the driving pulse PS12, a medium amount of ink is ejected, and thereby a medium dot is formed on the paper sheet.

When the pixel data is [11], the switch is turned on and off in accordance with the selection signal q3, the second and fourth interval signals SS12 and SS14 of the driving signal COM are applied to the piezo element, and the piezo element is driven in accordance with the driving pulses PS12 and PS14. When the piezo element is driven in accordance with the driving pulses PS12 and PS14, a large dot is formed on the paper sheet.

In this embodiment, the driving signal generating section 71 outputs driving pulses PS11 to PS14 having waveforms (voltages) designated by waveform data that is set by the controller 60. To be described later, when the waveform data changes, the waveforms (voltages) of the driving pulses PS11 to PS14 are changed.

### Ink Supply Path

FIG. 6 is a diagram showing supply of ink to the head.

Here, supply of black ink will be described. However, supply of ink of other colors is the same as that of the black ink. In addition, for the convenience of description, the number of heads is set to four.

A black ink cartridge is a housing body for housing black ink. The black ink cartridge can be detachably attachable to the printer. The black ink housed in the black ink cartridge passes through a supply path 91 and is supplied to the head.

In the middle of supply of the black ink from the black ink cartridge installed to the printer to the head, a heater 81 of the temperature control unit 80 is disposed. The heater 81 heats ink in the supply path 91 until the ink reaches a predetermined temperature (for example, 50 degrees). In other words, the ink right after passing through the heater 81 has a predetermined temperature.

In this embodiment, the supply path 91 is branched right after the position of the heater 81 (in other words, a branch point is right after the position of the heater 81). In a description below, supply paths that are branched are referred to as branched supply paths 92. In addition, a branched supply path that supplies ink to a first head 41A is referred to as a first branched supply path 92A, a branched supply path that supplies ink to a second head 41B is referred to as a second branched supply path 92B, and so on.

In a line printer, since a plurality of heads 41 is disposed to be aligned in the paper width direction (see FIG. 4A), distances between the heads 41 and the heater 81 are different from one another. Accordingly, the lengths of the branched supply paths 92 that supply ink to the heads are different from one another. For example, the first head 41A is disposed closer to the heater 81 than the fourth head 41D, and accordingly, the first branched supply path 92A is shorter than a fourth branched supply path 92D.

Through each branched supply path 92, the ink heated by the heater 81 flows. The temperate of the ink heated by the heater 81 decreases due to heat emission as the ink flows through the branched supply path 92. Accordingly, even when the temperature of the ink right after the ink passes through the heater 81, is, for example, 50 degrees, the temperature of the ink at a time when the ink reaches the head 41 is lower than 50 degrees.

Since the lengths of the branched supply paths 92 are different from one another depending on the heads, arrival time periods from a time when ink passes through the header 81 to a time when the ink reaches the heads are different from one another depending on the heads. Accordingly, the temperatures of the ink at the time when the ink reaches the heads become different from one another depending on the heads. For example, there is a case where the temperature of ink that has reached the first head 41A is 45 degrees and the temperature of ink that has reached the fourth head 41D is 35 degrees.

In addition, even when the lengths of the branched supply paths 92 are the same and the amounts of ejection of ink of the heads are different from one another, the arrival time periods from a time when ink passes through the heater 81 to a time when the ink reaches the heads become different from one another depending on the heads. In such a case, the temperatures of ink at a time when the ink reaches the heads become different from one another depending on the heads.

Ink has a property that its viscosity changes depending on the temperature. When the viscosity of the ink changes, the behavior of the ink inside a nozzle is changed. Accordingly, even when piezo elements are driven in accordance with driving signals having a same waveform, the sizes of ejected ink droplets are different in a case where the temperatures of the ink are different, and thereby the sizes of formed dots become different. As a result, there is a possibility that the quality of image is deteriorated due to occurrence of irregularity of dot sizes constituting a print image.

Thus, in the following embodiments described below, the waveform of the driving signal COM that is used for driving the head is changed in accordance with the temperature of ink. In addition, since there is a case where temperatures of the ink for the heads are different from one another in a line printer, the waveform of the driving signal COM is changed for each head.

### First Embodiment

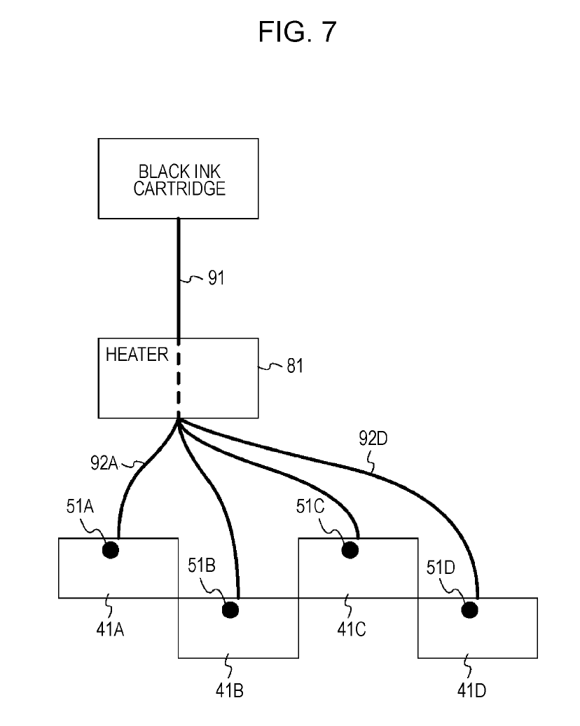

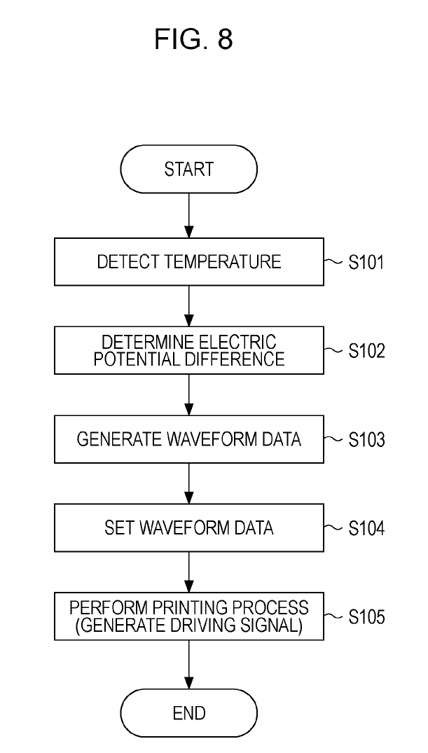

FIG. 7 is a schematic diagram showing the configuration of a first embodiment. FIG. 8 is a flowchart of the first embodiment.

In the first embodiment, a temperature sensor 51 is disposed in each head 41. Hereinafter, a temperature sensor disposed in the first head 41A is referred to as a first temperature sensor 51A, and a temperature sensor disposed in the second head 41B is referred to as a second temperature sensor 51B. Here, the first temperature sensor 51A disposed in the first head 41A and ejection of ink from the first head 41A will be mainly described.

First, the first temperature sensor 51A detects the temperature of ink in the first head 41A and outputs the result of detection to the controller 60 (S101). Next, the controller 60 determines an electric potential difference based on the detected temperature by referring to an electric potential difference determining table stored in the memory 63 (S102).

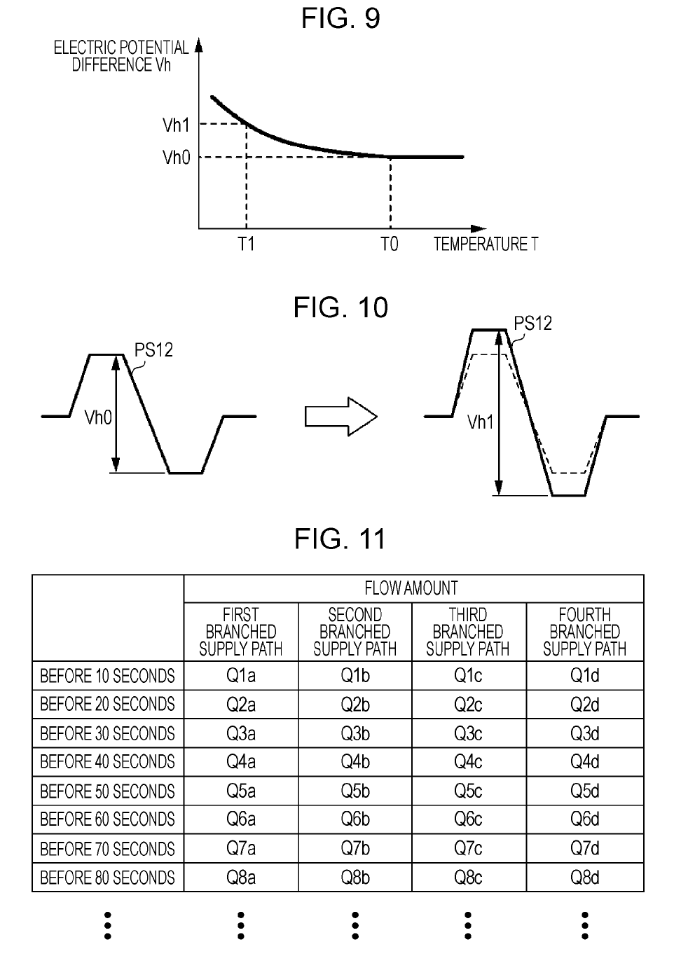

FIG. 9 is a diagram for describing the electric potential difference determining table. In the figure, the horizontal axis represents a temperature, and the horizontal axis represents the magnitude of a voltage value Vh. As shown in the figure, as the temperature T increases, the value of the electric potential difference Vh decreases. In addition, for a temperature equal to or higher than a predetermined temperature T0, the electric potential difference becomes a constant value Vh0. For example, when the temperature detected by the first temperature sensor 51A is T1, the controller 60 determines the electric potential difference Vh1 by referring to the electric potential difference determining table.

The electric potential difference determining table shown in the figure represents the electric potential difference Vh1 of the driving pulse PS12. Electric potential difference determining tables for other driving pulses are also stored in the memory 63, and the controller 60 determines electric potential differences of each driving pulse based on the detected temperature in the same manner.

FIG. 10 is a diagram showing the driving pulse PS12 and the electric potential difference Vh. On the left side of the figure, the driving pulse PS12 of the driving signal COM before change is shown.

In the driving pulse PS12, after the electric potential increases to a highest electric potential from an intermediate electric potential, the electric potential is maintained at the highest electric potential for a predetermined time. Then, the electric potential decreases from the highest electric potential to a lowest electric potential and is maintained at the lowest electric potential for a predetermined time. Thereafter, the electric potential increases to the intermediate electric potential. In the driving pulse PS12 of the driving signal COM before change, an electric potential difference between the highest electric potential and the lowest electric potential is Vh0. When the electric potential changes from the highest electric potential to the lowest electric potential, that is, when the piezo element is transformed by electric discharge, ink droplets are ejected from the nozzle. Accordingly, the size of the ink droplets ejected from the nozzle is highly dependent on the electric potential Vh0.

When the detected temperature is T1, the controller 60 determines the electric potential difference as Vh1 (S102) and generates waveform data corresponding to the electric potential difference Vh1 (S103). The generated waveform data is configured by data representing time points of voltage change points and electric potentials. Then, the controller 60 sets the generated waveform data in the driving signal generating section 71 that generates the driving signal COM of the first head 41A (S104).

When the waveform data is set in the driving signal generating section 71, a printing process is started (S105). In the printing process, the head unit 40 ejects ink onto a paper sheet that is in a transport process while the transport unit 20 transports the paper sheet in the transport direction, and thereby an image is printed on the paper sheet. At this moment, the driving signal generating section 71 that generates the driving signal COM used for driving the first head 41A outputs a driving signal COM including a driving pulse as shown on the right side of the figure, based on the set waveform data. As described above, by setting the waveform data on the basis of the temperature, the waveform of the driving signal COM is changed.

When the temperature of ink in the first head 41A is low, the viscosity of the ink becomes high. Accordingly, when the driving signal COM is not changed, an ejected ink droplet become small, and thereby the size of a dot decreases. On the contrary, in this embodiment, when the first temperature sensor 51A detects that the temperature of the ink in the first head 41A is low, the waveform of the driving signal COM is changed so as to increase a voltage change, and accordingly, the size of an ejected ink droplet increases. Accordingly, even when the temperature of the ink in the first head 41A is low, the size of the ink droplet ejected from the first head 41A is not changed.

In the description above, although ejection of ink from the first head 41A has been described, however, a same process is performed for other heads 41. In addition, the driving signal generating section 71 that generates the driving signal COM used for driving the first head 41A and the driving signal generating section 71B that generates the driving signal COM used for driving the second head 41B are provided independently. Then, the second head 41B is driven in accordance with the driving signal COM of which waveform has been changed based on the temperature (the temperature of the ink in the second head 41B) detected by the second temperature sensor 51B.

As described above, by changing the waveform of the driving signal COM for each head in accordance with the temperature of ink in each head, the irregularity of sizes of ink droplets among the heads can be suppressed. Particularly, lengths of the branched supply paths 92 for each head are different for a line printer, and accordingly, the irregularity of the temperatures of ink among the heads may easily occur. However, according to this embodiment, the irregularity of sizes of ink droplets among the heads can be suppressed. In addition, especially when low-viscosity ink is used, a change in the viscosity for the change of the temperature is large, and accordingly, this embodiment can be effectively applied.

### Second Embodiment

According to the above-described first embodiment, the temperature sensor 51 is disposed in each head, and the temperature of ink in each head is directly detected (S101 shown in FIG. 8). On the other hand, according to a second embodiment, the temperature sensor 51 is not disposed, and the temperature of ink in each head is calculated based on the flow amount (in other words, the flow amount of ink supplied to each head) of ink flowing through the branched supply path 92.

In this embodiment, the controller 60 detects the flow amount of ink that flows for 10 seconds through each branched supply path 92 and generates flow amount history data by sequentially storing the flow amount information in the memory 63.

FIG. 11 is a diagram showing the flow amount history data. The flow amount of ink flowing through each branched supply path 92 is equivalent to the amount of ink ejected from a corresponding head. For example, the amount of ink flowing through the first branched supply path 92A is equivalent to that of ink ejected from the first head 41A. Thus, the controller 60 calculates the amount of ink ejected from each head for 10 seconds and sets the amount of ink as the amount of ink flowing through each branched supply path 92 for 10 seconds.

The amount of ink ejected from each head for 10 seconds is calculated based on the pixel data (the pixel data included in the print data) used for ink ejection for 10 seconds. In particular, there are three types of dot counters (not shown) in the controller 60. The counters counts the number of pixel data values of [11] representing a large dot, the number of pixel data values of [10] representing a medium dot, and the number of pixel data values of [01] representing the number of small dots. Then, the controller 60 calculates the amount of ejected ink based on a count value of each counter and the sizes of the ink droplets corresponding to each dot, after 10 seconds elapse from stating the count operation. In addition, the counters are reset and start to count the numbers again, every 10 seconds.

Even when a printing operation is not performed, the controller 60 sets the amount of ink flowing through each branched supply path 92 for 10 seconds to zero and stores the flow amount information in the memory 63. In addition, in a temperature calculating process to be described later or another process, the controller detects the amount of ink flowing through each branched supply path 92 for 10 seconds and stores the flow amount information in the memory 63 in parallel with performing the process.

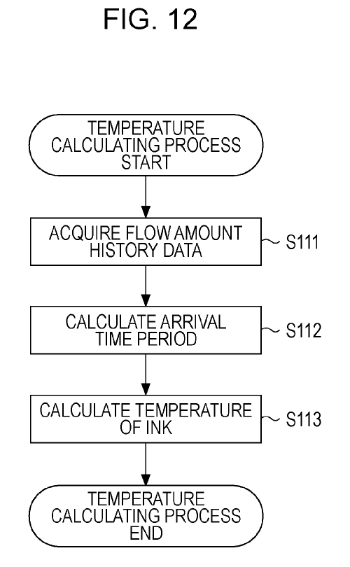

FIG. 12 is a flowchart showing the temperature calculating process according to the second embodiment. This temperature calculating process is performed instead of the above-described process of S101.

First, the controller 60 reads out the flow amount history data (see FIG. 11) stored in the memory 63 (S111).

Next, the controller 60 calculates a time (an arrival time period) required for ink currently located in the head to reach the head 41 after the ink currently in the head passed through the heater 81 (S112). In other words, the controller 60 calculates how many seconds ago the ink currently located in the head passed the heater 81.

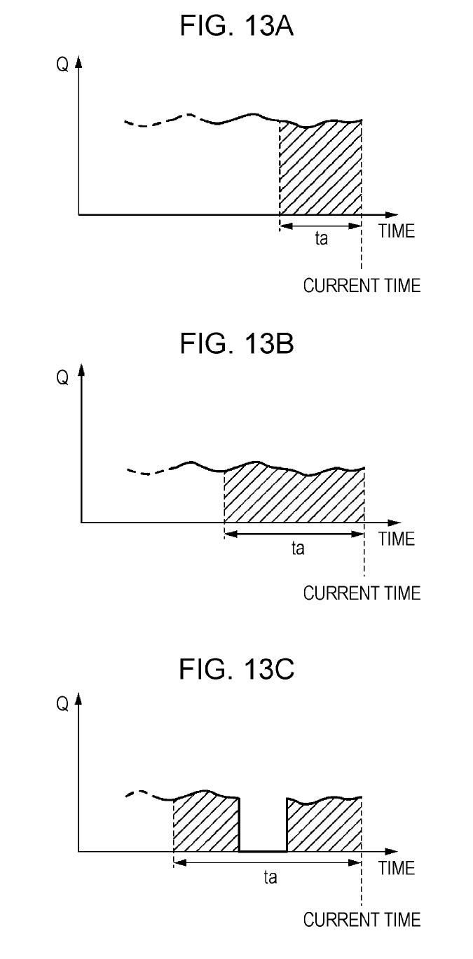

FIGS. 13A to 13C are diagrams showing a process for calculating the arrival time period. The graphs shown in the figures are graphs of flow amount history data of the first branched supply path 92A. In the figure, the horizontal axis represents a time, and the vertical axis represents a flow amount. The controller 60 sequentially accumulates the flow amounts in order from the latest information to the oldest information, and stops the accumulation process when the accumulated flow amount reaches the volume of the first branched flow path 92A. Here the flow amounts are orderly accumulated as Q1a+Q2a+Q3a+ . . . . Then, when the flow amount accumulated finally is information n seconds ago, the arrival time period is set to n seconds.

In FIG. 13A, the area of a shaded part corresponds to the volume of the first branched supply path 92A. In addition, a time period ta corresponds to the arrival time period.

FIG. 13B is a diagram showing a case where the flow amount is smaller than that shown in FIG. 13A. The area of the shaded part shown in FIG. 13B corresponds to the volume of the first branched supply path 92, and accordingly, the area of the shaded part of FIG. 13B is the same as that of FIG. 13A. As the flow amount of ink flowing through the branched supply path decreases, the arrival time period is lengthened.

FIG. 13C is a diagram showing a case where a printing operation is not performed for a time period in the middle of the operation. In this case, accumulation may be performed in the same manner as described above. Since the flow amount for the time period in the middle of the operation is zero, the arrival time period is lengthened.

For a line printer, the lengths of the branched supply paths 92 are different for each head, and accordingly, the volumes of the branched supply paths are different for each head. Accordingly, even when the flow amount history data values are the same, the arrival time periods are different for each head. For example, when the flow amount history data values are the same, the branched supply path 92 of the first head 41A is shorter than that of the fourth head 41D, and accordingly, the arrival time period for the first head 41A is shorter than that of the fourth head 41D.

In addition, even when the lengths of the branched supply paths 92 are the same, if the flow amount history data values are different, the arrival time periods become different. For example, when the lengths of the first branched supply path 92A and the fourth branched supply path 92D are the same and the flow amount of the first branched supply path 92A is larger than that of the fourth branched supply path 92D, the arrival time period of the first head 41A is shorter than that of the fourth head 41D. In addition, for the first branched supply path 92A, the arrival time period for a case where the flow amount is large (a case where a print operation for ejecting a large amount of ink is continuously performed) is shorter than that for a case where the flow amount is small (a case where a print operation for ejecting a small amount of ink is continuously performed).

Next, the controller 60 calculates the temperatures of the ink in each head (S113). Since the ink arriving in each head has emitted heat in the branched supply path 92A for the arrival time period, the controller 60 calculates the temperature T of the ink in the first head 41A by using the following equation.

T=T1+(T0−T1)×(1−exp(−t/α))

In the above equation, T0 denotes an external temperature and is detected by an external temperature sensor not shown in the figure. T1 denotes the temperature of ink right after passing the heater. In addition, t denotes an arrival time period calculated in the process of S112. A coefficient α is a coefficient representing the degree of heat emission of each branched supply path 92. As the coefficient α, a value that has been acquired in advance by experiments is stored in the memory 63.

When the arrival time periods for each head are different, temperatures of ink in each head are different for each head. As the arrival time period decreases, the temperature of the ink in the head increases. When the flow amount history data values are the same, the arrival time period of the first head 41A is shorter than that of the fourth head 41D, and accordingly, the temperature of the ink in the first head 41A is higher than that in the fourth head 41D.

By performing the above-described temperature calculating process, the controller 60 calculates the temperatures of ink in each head. Since the process after the temperatures of ink are calculated in the second embodiment is the same as the process of S102 to S105 shown in FIG. 8, a description thereof is omitted here. According to this embodiment, by changing the waveform of the driving signal COM in accordance with the temperature of ink in each head for each head, the irregularity of sizes of the ink droplets among the heads can be suppressed.

In addition, in this embodiment, the temperatures of the ink in each head are calculated based on the print data, and accordingly, the temperature sensor can be omitted. Accordingly, in this embodiment, the temperature sensor can be omitted, and thereby it can be achieved that the cost is lowered down and the space is saved.

In addition, in this embodiment, the temperatures of ink are calculated based on the arrival time periods to the heads form the heater. Accordingly, the temperatures of the ink of each head can be calculated with temperature changes due to heat emission of liquids in the supply paths considered.

### Modified Example of Second Embodiment

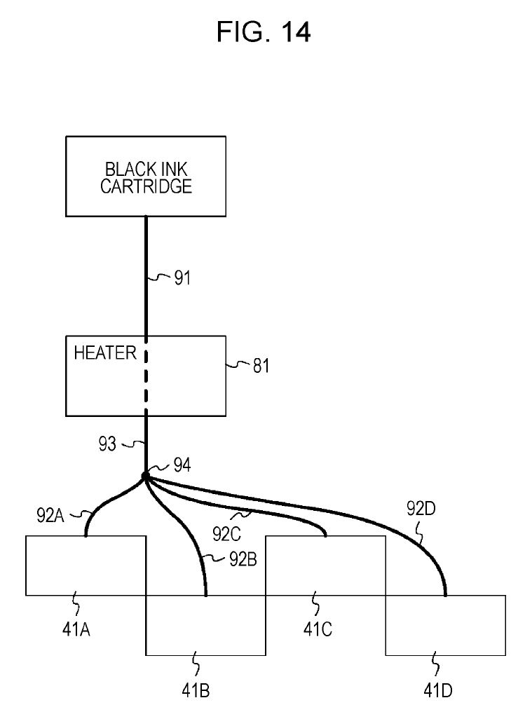

FIG. 14 is a diagram showing a modified example of a supply path. In the above-described embodiment, the supply path is branched righter after the position of the heater 81. However, in this modified example, after ink heated by the heater 81 flows though a common supply path 93, the ink is branched at a branch point 94 and supplied to each head 41 through each branched supply path 92.

In this modified example, the controller 60 calculates the amounts of ejected ink from each head for 10 seconds, sequentially stores information on the flow amounts of ink flowing through the branched supply paths 92 for 10 seconds in the memory 63, and generates the flow amount history data. Since the flow amount history data has been described above, a detailed description thereof is omitted here.

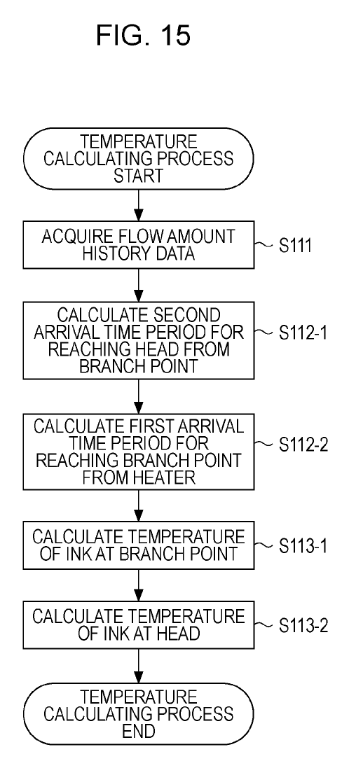

FIG. 15 is a flowchart showing a modified example of the temperature calculating process. This temperature calculating process is performed instead of the above-described process of S101.

First, the controller 60 reads out the flow amount history data (see FIG. 11) stored in the memory 63 (S111).

Next, the controller 60 calculates time periods (second arrival time periods) required for ink, which is currently located in the heads, to arrive at the heads 41 after the ink passes through the branch point 94 (S112-1). In other words, the controller 60 calculates how many seconds ago the ink that is currently located in the heads passed the branch point 94.

In the process of S112 shown in FIG. 12, the arrival time periods from the heater 81 to the heads 41 are calculated. However, in the process of S112-1 of this modified example (FIG. 15), the second arrival time periods not from the heater 81 but from the branch point 94 to the heads 41 are calculated. Although the ink flows from the heater 81 to the branch point 94 and then flows from the branch point 94 to the heads 41, the arrival time periods (the second arrival time period) from the branch point 94 to the heads 41 are calculated in an arrival time period calculating process before an arrival time period (first arrival time period) from the heater 81 to the branch point 94 is calculated.

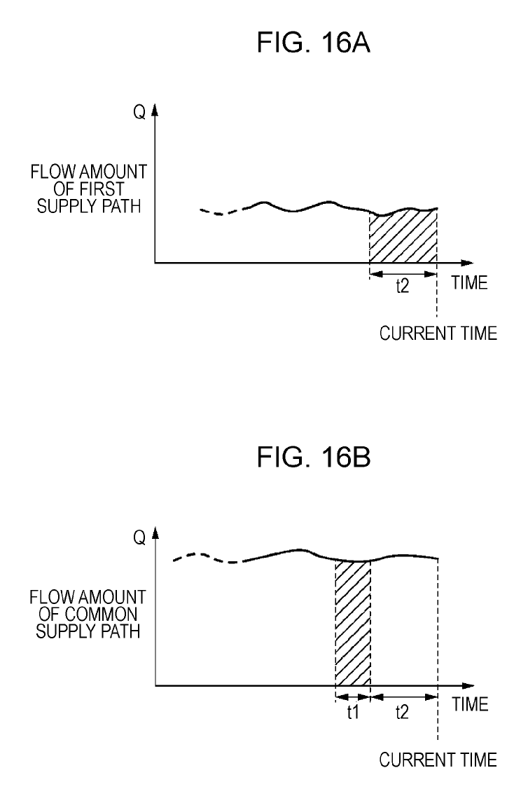

FIG. 16A is a diagram showing a process for calculating the second arrival time periods from the branch point 94 to the heads 41. A graph shown in the figure is a graph of flow amount history data of the first branched supply path 92A. In the figure, the horizontal axis represent a time, and the vertical axis represents a flow amount. The controller 60 accumulates the flow amount in order from the latest information to the oldest information. Then, when the accumulated flow amount reaches the volume (a volume of a flow path from the branch point 94 to the head 41) of the first branched supply path 92A, the controller 60 stops accumulating the flow amount. Then, when the flow amount finally accumulated is information n2 seconds ago, the controller 60 sets the second arrival time period as n2 seconds. This calculating method is almost the same as that of the above-described embodiments. Accordingly, the second arrival time periods for each head are different from one another based on the same reason that the arrival time periods for each head are different from one another in the above-described embodiments.

Next, the controller 60 calculates the time period (the first arrival time period) required for ink, which was located at the branch point 94 the second arrival time period ago, to reach the branch point 94 after passing the heater 81 (S112-2). In other words, the controller 60 calculates how many seconds ago the ink, which was at the branch point 94 the second arrival time period ago, passed the heater 81.

In the process of S112 shown in FIG. 12, the arrival time periods from the heater 81 to the heads 41 are calculated. However, in the process of S112-2 of this modified example (FIG. 15), the arrival time period (the first arrival time period) not to the heads 41 but to the branch point 94 is calculated.

FIG. 16B is a diagram showing a process for calculating the first arrival time period from the heater 81 to the branch point 94. A graph shown in the figure is a graph of flow amount history data of the common flow path 93.

In the above-described FIG. 13A or 16A, the flow amount history data of the first branched supply path 92A is shown. However, in FIG. 16B, the flow amount history data of the common supply path 93 is shown. The flow amount of the common supply path 93 is a sum of the flow amounts of the first branched supply path 92A to the fourth branched supply path 92D. Accordingly, the flow amount history data of the common supply path 93 can be acquired from the flow amount history data of the first branched supply path 92A to the fourth branched supply path 92D.

The controller 60 sequentially accumulates the total flow amount (the flow amount of the sum of the first branched supply path 92A to the fourth branched supply path 92D) from the information the second arrival time period ago. Then, when the accumulated total flow amount reaches the volume (the volume of the flow path from the heater 81 to the branch point 94) of the common supply path 93, the controller 60 stops the accumulation process. Then, when the flow amount finally accumulated is information n1 seconds before the second arrival time period, the controller 60 sets the first arrival time period as n1 seconds.

In addition, in the above-described FIG. 13A or 16A, the flow amounts are sequentially accumulated from the latest information to the oldest information. However, in the process of S112-2 of this modified example, the flow amounts are sequentially accumulated not from the latest information but from information the second arrival time period ago. The calculation process is performed as described above, and accordingly, the arrival time period (the second arrival time period) from the branch point 94 to the head 41 is calculated in the process of S112-1 before the arrival time period (the first arrival time period) from the heater 81 to the branch point 94 is calculated.

However, the second arrival time periods are different for each head, and accordingly, the start time points for the accumulation process which are shown in FIG. 16B are different for each head. As a result, although the common flow path 93 is a flow path common to all the heads, the first arrival time periods representing time periods for which ink flows the common flow path 93 are different for each head. In addition, by calculating the first arrival time period as described above, the temperatures of ink in each head can be precisely calculated.

When the first arrival time period is calculated, not only the flow amount history data of the first branched supply path 92A but also the flow amount history data of other branched supply paths 92B to 92D is used. As the flow amounts of other branched supply paths 92B to 92D increase, the first arrival time period used for calculating the temperature of ink in the first head is shortened. As described above, according to this modified example, when the temperature of ink of a head (for example, the first head) is calculated, not only the flow amount of ink supplied to the head (for example, the first head) but also the flow amounts of ink supplied to other heads (for example, the second head to the fourth head) are considered. Accordingly, the temperatures of ink in each head can be precisely calculated.

Next, the controller 60 calculates the temperature of ink at the branch point 94 (S113-1). The ink arrived at the branch point 94 emits heat in the common supply path 93 for the first arrival time period, and thus, the controller 60 calculates the temperature Tj of ink at the branch point 94 by using the following equation.

Tj=T1+(T0−T1)×(1−exp(−t1/α1))

In the above equation, T0 denotes an external temperature and is detected by an external temperature sensor not shown in the figure. T1 denotes the temperature of ink right after passing the heater. In addition, t1 denotes a first arrival time period calculated in S112-2. A coefficient α1 is a coefficient representing the degree of heat emission of the common supply path 93. As the coefficient α1, a value that has been acquired by experiments in advance is stored in the memory 63.

Next, the controller 60 calculates the temperature of ink of the first head 41A (S113-2). The ink arrived at the head emits heat in the first branched supply path 92A for the second arrival time period, and thus, the controller 60 calculates the temperature T of ink at the first head 41A by using the following equation.

T=Tj+(T0−Tj)×(1−exp(−t2/α2))

In the above equation, Tj denotes the temperature of ink at the branch point 94 which has been calculated in the process of S113-1. In addition, t2 denotes the second arrival time period calculated in the process of S112-1. A coefficient a2 is a coefficient representing the degree of heat emission of the branched supply path 92.

By performing the above-described temperature calculating process, the controller 60 calculates the temperatures of ink in each head. In this modified example, the process after the ink-temperature calculating process is the same as that of S102 to S105 shown in FIG. 8, and thus a detailed description is omitted here.

According to this modified example, by changing the waveform of the driving signal COM for each head in accordance with the temperature of ink in each head, the irregularity of sizes of ink droplets among the heads can be suppressed. Particularly, the irregularity of the temperatures of ink among the heads may easily occur. However, according to this modified example, the irregularity of sizes of ink droplets among the heads can be suppressed.

### Other Embodiments

Although the printer and the like have been described as an embodiment of the invention, however, the above-described embodiments are for easy understanding of the invention and are not for purposes of limiting the invention. It is apparent that the present invention can be changed or modified without departing from the gist of the invention and the invention includes equivalents thereof. In particular, embodiments described below also belong to the invention.

### Printer

In the above-described embodiments, the printer 1 has been described as a line printer. However, the printer 1 may be a printer other than the line printer. For example, the printer 1 may be a printer in which a plurality of heads 41 is mounted on a carriage (not shown) and an image is printed on a paper sheet S by repeating a dot forming operation that is an operation for forming dots by ejecting ink from the heads 41 with the carriage moved in the moving direction and a transport operation that transports the paper sheet S in the transport direction by using a transport unit 20.

### Liquid Ejecting Apparatus

In the above-described embodiments, although the printer has been described, however, the invention is not limited thereto. For example, same technology applied to the embodiments may be applied to various liquid ejecting apparatuses such as a color filter producing apparatus, a coloring apparatus, a fine processing apparatus, a semiconductor producing apparatus, a surface processing apparatus, a three-dimensional molding machine, a liquid vaporizing apparatus, an organic EL producing apparatus (particularly, a polymer EL producing apparatus), a display producing apparatus, a film forming apparatus, and a DNA chip producing apparatus that use ink jet technology. In addition, the method used in the apparatuses and a method of manufacturing the apparatuses are within the range of application of the invention.

### Ink

In the above-described embodiments, the invention is embodied as a printer, and accordingly, ink is ejected from the head. However, the liquid ejected from the head is not limited to the above-described ink. For example, a liquid (including water) such as a metal material, an organic material (particularly, a polymer material), a magnetic material, a conductive material, a wiring material, a film forming material, electronic ink, a treating liquid, or a gene liquid may be ejected from a nozzle.

### Nozzle

In the above-described embodiments, ink is ejected by using a piezo element. However, a method of ejecting a liquid is not limited thereto. For example, a different method such as a method of generating bubbles inside a nozzle by using heat may be used.

### Temperature Control Unit

In the above-described temperature control unit, a heater is disposed. However, the temperature control unit is not limited thereto, and a temperature control unit in which a cooler is disposed may be used. Basically, the temperature control unit that can control the temperature of ink may be used.

### Temperature Sensor

In the above-described first embodiment, the temperature sensor is disposed in each head. However, the place in which the temperature sensor is disposed is not limited to the head. For example, it may be configured that a temperature sensor is disposed in the supply path and the temperature sensor is configured to detect the temperature of ink in the supply path. Then, when the controller changes the waveform of driving signals for each head based on the result of detection of the temperature sensor, the irregularity of ink droplets among the heads can be suppressed. In addition, the controller is configured to calculate the temperature of ink in the head based on the result of detection of the temperature sensor disposed in the supply path by using the flow amount of ink as in the second embodiment.

In addition, in the above-described first embodiment, a plurality of the temperature sensors is needed. However, the number of the temperature sensor may be one. When only one temperature sensor is used, it is preferable that the temperature sensor is disposed in the common supply path. In addition, when only one temperature sensor is used, it is preferable that the temperature sensor is disposed in the branch point for simplifying the operation for calculating the temperature of ink in each head based on the temperature sensor and the flow amount of ink.

### Flow Amount of Ink

In the above-described second embodiment, the flow amount of the ink is calculated based on the print data. However, the method of calculating the flow amount of the ink is not limited thereto. The flow amount of the ink may be directly detected by using a flow amount sensor.

The entire disclosure of Japanese Patent Application No. 2007-192226, filed Jul. 24, 2007 is expressly incorporated by reference herein.

What is claimed is:

1. A liquid ejecting apparatus comprising:
a plurality of heads that eject liquids;
a plurality of driving signal generating units, one of the driving signal generating unit being disposed in one of the head and generates driving signal used for driving the head;
a temperature control unit that controls temperatures of the liquids;
a supply path that supplies the liquids of which temperatures are controlled by the temperature control unit to the plurality of heads; and
a controller that changes the driving signals, one of the driving signal being generated by the driving signal generating unit corresponding to the head, based on the temperature of the liquid corresponding to the head.

2. The liquid ejecting apparatus according to claim 1, further comprising a plurality of temperature sensors, one of the temperature sensor being disposed in one of the head and is used for detecting the temperature of the liquid in the head,
wherein the controller changes the driving signals, one of the driving signal being generated by the driving signal generating unit corresponding to the head, based on result of detection of the temperature sensor corresponding to the head.

3. The liquid ejecting apparatus according to claim 1, further comprising a temperature sensor that is disposed in the supply path and is used for detecting the temperature of the liquids in the supply path,
wherein the controller changes the driving signals, one of the driving signal being generated by the driving signal generating unit corresponding to the head, based on a result of detection of the temperature sensor corresponding to the head.

4. The liquid ejecting apparatus according to claim 1,
wherein the controller calculates the temperature of the liquid in the head based on flow amounts of the liquid supplied to the head.

5. The liquid ejecting apparatus according to claim 4,
wherein the controller controls ejection of the liquid from the head based on print data, and
wherein the controller calculates the flow amount of the liquid supplied to the head based on the print data and calculates the temperature of the liquid in the head based on the calculated flow amount.

6. The liquid ejecting apparatus according to claim 4,
wherein the controller calculates arrival time period in which the liquid reaches the head from the temperature control unit based on the flow amount of the liquid supplied to the head and calculates the temperature of the liquid in the head based on the arrival time period.

7. The liquid ejecting apparatus according to claim 6,
wherein the supply path includes a common supply path, a branch point, and a plurality of branched supply paths,
wherein the liquid of which temperature have been controlled by the temperature control unit flow through the common supply path, then are branched at the branch point, and flow through the branched supply paths to be supplied to the head, and
wherein the controller calculates arrival time period in which the liquid reaches the head from the branched point and then calculates arrival time period in which the liquid reaches the branch point from the temperature control unit.

8. The liquid ejecting apparatus according to claim 7,
wherein the controller, for calculating the temperature of the liquid in a head among the plurality of heads, calculates an arrival time period, in which the liquid reaches the head from the branch point, based on the flow amount of the liquid supplied to the head and calculates an arrival time period, in which the liquid reaches the branch point from the temperature control unit, based on the flow amount of the liquid supplied to the head and the flow amount of the liquid supplied to another head.

9. A liquid ejecting method for ejecting liquids from a plurality of heads, the method comprising:
controlling temperatures of the liquids;
supplying the liquids of which temperatures are controlled to the plurality of heads;
changing driving signal used for driving the head based on the temperature of the liquid corresponding to the head, and
ejecting the liquid from the head by driving the head by using the changed driving signal.
